(19) United States
(12) Patent Application Publication
(10) Pub. No.: US 2013/0199122 A1
(43) Pub. Date: Aug. 8, 2013

(54) NATURAL THERMAL CUT WINDOW AND DOOR FRAME

(71) Applicant: Giuseppe Esposito, San Biagio Di Callalta(TV) (IT)

(72) Inventor: Giuseppe Esposito, San Biagio Di Callalta(TV) (IT)

(73) Assignee: PALLADIO S.P.A., SAN BIAGIO DI CALLALTA (TV) (IT)

(21) Appl. No.: 13/635,886

(22) PCT Filed: Apr. 15, 2011
(86) PCT No.: PCT/IT2011/000117

§ 371 Date: Jan. 14, 2013

(30) Foreign Application Priority Data
Apr. 26, 2010 (IT) VI2010A000113

(51) Int. Cl. E06B 7/02; E06B 1/04

(52) U.S. Cl. CPC E06B 7/02; E06B 1/04
USPC 52/656.2

(57) ABSTRACT

A natural thermal cut window and door frame (1) comprising a first section bar (2; 51), suitable to be fixed to the perimetric wall delimiting a room of a building, and a second section bar (3; 52) cooperating with said first section bar (2) in order to hermetically close the room itself, a pair of front panels supported by the second section bar (3), suitable to form the interface between the outer environment and the inner environment of the building. In particular, each of the aforesaid section bars (2, 3; 51) is composed of at least two shaped portions (4, 5; 53, 54) distinct and independent each other, connected each other through union means (6), in order to define between the shaped portions (4, 5; 53, 54) a thermal insulation slot (7) suitable to allow air circulation from/to the outer environment to/from the inner environment, and provided with reinforcement means (8) suitable to assure structural rigidity.

The current invention concerns a natural thermal cut window and door frame for rooms, for example windows, doors, faces and the like, of buildings.

As known, window and door frames for closing rooms of buildings have been available on the market for a long time to which higher and higher and more and more effective capacities of thermal insulation from the atmospheric agents, such as air, or wind, and water that inevitably affect them, are required.

The window and door frames must also contribute to acoustically isolate the environments or rooms of the buildings from noise coming from the outside, which can disturb people's normal work, recreational and/or rest activities.

In addition to such features, the window and door frames however must necessarily have physical properties such as lightness, in order to be handled by the user without particular difficulties or hindrances, whether they can be opened, mechanical strength, structural strength and non-deformability under the action of the atmospheric agents and continuous cycles of opening and closing, in order to ensure a perfect seal in closing conditions and deter or effectively bar acts of vandalism.

The window and door frames made of wood are notoriously easy to be built and present a remarkable capacity of thermal insulation, thanks to the insulating properties typical of the wood.

However, given the increased requirements related to the sizes of window and door frames and, more in detail, to the shape of the panels, especially made of glass (which are thicker and thicker and heavier and heavier in order to provide adequate insulation and mechanical strength) mounted on the perimetric section bars, the window and door frames themselves are often made of wood and/or metallic material such as aluminium or steel, as well as wood and/or plastic material such as polyvinylchloride (PVC).

These window and door frames typically include a first metallic, such as steel, tubular section bar which is fixed to the perimetric wall delimiting the room, and a second metallic tubular section bar which cooperates with the first section bar in order to hermetically close the room and supports one or more front panels of interface between the outer environment and the inner environment of a room of the building.

The tubular section bars, thanks to the structural strength and non-deformability guaranteed to them by the metallic material which they are made of, present good mechanical and atmospheric agents strength, especially when used to support large slabs of glass in significant dimensions window and door frames.

Nevertheless, these tubular metallic section bars of the window and door frames of the prior art do not give the necessary properties of thermal insulation.

In order to solve such a problem, metallic window and door frames of the so-called “thermal cut” type have been proposed on the market for some years, which include an element made of low thermal conductivity, for example a plastic fibres aggregate or a polyamide component, inserted into each of the yet mentioned tubular section bars.

Such a thermally insulating element limits the passage of heat from the inner environment to the outside, thereby avoiding the formation of thermal bridges usually around the perimeter of doors and windows.

However, the thermal cut window and door frames of the prior art present the drawback of the so-called “bimetal effect”: the outer tubular section bar and inner tubular section bar, being at reciprocally different temperatures, inevitably undergo unhomogeneous thermal expansions that cause dangerous deformation of the section bars themselves, especially if the latter are made of aluminium (excellent heat conductor notoriously).

This partially but in nay case significantly limits the tightness of the window and door frames in closing conditions, thus causing thermal dissipations on one hand, infiltrations, responsible for the formation and proliferation of moulds and other bacterial colonies, and drastic reductions in the degree of the acoustic insulation of the building rooms on the other hand.

The constructive solution today widely adopted of positioning an insulating material element in the central section of each of the tubular section bars of the window and door frames thus substantially reduces the properties of mechanical strength of the section bars in question.

Another relevant drawback affecting the thermal cut window and door frames is constituted by the fact that the welding seam which must be applied at some areas of the section bars in order to ensure a prolonged structural stability over time gives off toxic fumes from the plastic insulating element present inside each section bar.

The presence of the insulating element also complicates the procedures of painting of the section bars of the window and door frame: since the paint adheres to the plastic material in a way obviously different with respect to the metallic material, it is necessary to differentiate the painting process depending on the constructive elements concerned of the window and door frame, by performing an its meticulous and finely controlled adjustment.

A last but not least drawback of the thermal cut window and door frames of the known technology is due to the fact that, in some cases, the tubular section bars should be undergone, for the type of application to which are intended, a glazing working in order to smooth and superficially polish them.

In case of thermal cut window and door frames of traditional type, such glazing working cannot be performed because, by providing a significant pressure on the metallic tubular section bar, would seriously compromise the connection between the insulating material element and the tubular section bar.

The insulating element contained inside the section bars significantly worsens, moreover, the aesthetic effect offered by the known thermal cut window and door frames, in opening conditions.

Document FR2149360 discloses a window and door frame of the so-called natural thermal cut type wherein each of the two section bars is formed by a couple of shaped portions distinct each other, reciprocally connected through union means defining between the shaped portions themselves a thermal insulation slot which allows air recirculation from/to the outer environment to/from the inner environment.

The shaped portions are also provided with hooking means suitable to retain the union means more than guarantee the structural rigidity to the connection between the latter and the section bars.

In particular, the union means include a series of shanks, each of which made of synthetic material and substantially representing a simple spacer element which predominantly provides thermal cut just by virtue of the material with low thermal conductivity value which constitutes it and is, therefore, little suit to bear torsional stresses and give structural rigidity to the section bar as a whole.

Such a structural rigidity is notoriously requirement that cannot be disregarded especially for window and door frames of big dimensions where the weight itself of the shutters—at the moment of their opening—leads to dangerous bending and possible deformations of the section bar which forms the frame that can be open of the window and door frame.

Furthermore, just to allow the manoeuvre of insertion and hooking of the various shanks to the section bars, in FR2149360 it is necessary to provide a certain gap between the two shaped portions of the two section bars: however minimum, such a gap is still evident and leaves at sight the union means, unavoidably breaking the structural continuity of the window and door frame and, thus, negatively affecting the aesthetic effect of the latter, especially when the shutter is open and with direct sight on the mutual hooking system of the parts forming the section bars of the window and door frame.

In addition, the union shanks present a fixed and predetermined length, suitable to connect two shaped portions of a single and well precise type of section bar, thus not allowing no format adjustment and/or flexibility: this means that it is necessary to provide as many models of union shanks as many types of section bars which can be mounted and available in commerce are, with the obvious disadvantages of productive efficiency and logistic management that result.

The present invention aims to overcome the drawbacks of the known technique just mentioned.

In particular, primary purpose of the present invention is to create a natural thermal cut window and door frame which keeps its properties of mechanical strength and tightness unchanged over time or however for a time period longer than that one allowed by the window and door frames of the known type.

Within this purpose, it is a first task of the invention to provide a natural thermal cut window and door frame which presents a capacity of thermal and acoustic insulation of the building rooms better than that one of the known window and door frames.

It is a second task of the invention to develop a natural thermal cut window and door frame that, compared to the equivalent prior art, limits the onset of infiltrations and, consequently, the proliferation of moulds and other bacterial colonies, as well as fogging phenomena of the surfaces of the glass slabs or panels housed in one of the tubular section bars.

It is another purpose of the invention to give substance to a natural thermal cut window and door frame which averts the emission of toxic fumes during its production process and, in particular, during the necessary welding operations to be performed on it.

As part of the aforesaid requirement, it is task of the present invention to design a natural thermal cut window and door frame which, during production, presents an environmental impact better than what it is permitted by the prior art window and door frames.

It is also task of the invention to conceive a natural thermal cut window and door frame which safeguards workers' health intended for its production in a factory at a greater extent than today.

It is a further purpose of the present invention to make available a natural thermal cut window and door frame which, with respect of the prior art, makes easier and more efficient the painting of the section bars of the window and door frame.

It is also purpose of the present invention to allow to perform any working or treatment of metallurgy, such as glazing on the elements of a thermal cut window and door frame.

It is another purpose of the invention to produce a natural thermal cut window and door frame which offers an aesthetic effect better than that one of known window and door frames, mostly in opening conditions.

It is a last but not least purpose of the invention here appended to ease the disposal of the window and door frames at the end of their life cycle, making them more biocompatible than the window and door frames of the known type.

Said purposes are achieved through a natural thermal cut window and door frame according to attached claim 1, as hereinafter referred for the sake of brevity.

Other constructive features of detail of the window and door frame of the invention are set forth in the corresponding dependent claims.

Advantageously, the window and door frame of the invention presents excellent features of mechanical strength, toughness, non-deformability and tightness in application conditions, when closed, while being extremely compact and of small dimensions.

This even and especially thanks to the presence of the reinforcement means, preferably a pair of tongues arranged at the middle zone of the first section bar and second section bar of the window and door frame.

Still advantageously, the window and door frame of the invention provides a very effective thermal insulation obtained in natural way thanks to the presence of the thermal insulation slot, defined between the shaped portions preferably of both the section bars, and allowing air circulation from the outer environment to the inner environment and vice versa.

Such a slot creates, indeed, a continuous flow of air which, due to the difference in temperature between the inner environment and the outer environment, constantly circulates inside the inner chamber defined by at least one of the section bars.

This factor improves with respect to the prior art the overall performances of the window and door frame in terms of thermal insulation both in summer and in winter.

The continuous upward flow of air into the inner chamber of at least one of the section bars represents a constant thermal barrier that ensures perimetrical ventilation along the housing seat of the front panel or slab, thereby eliminating the problems of fogging and moulds proliferation, typical of the prior art, always harmful and/or undesired.

The window and door frame of the invention achieves, therefore, an efficient thermal cut even without the introduction of an insulating element made of plastic material into the section bars comprising it, as typically occurs in the common window and door frames of the known type.

Such a constructive aspect, equally advantageously, allows to eliminate the phenomenon of emission of toxic fumes during welding phases to which some areas of the section bars of the window and door frame are undergone, thereby safeguarding at a greater degree workers' health intended to such a work.

Moreover, the absence of insulating elements in the section bars determines the following advantages over the known art:
it makes easy the disposal of the window and door frame of the invention at the end of its cycle of use, making such a phase less invasive and critical than today from the environmental impact point of view;
it makes easy and more efficient the painting of the section bars, which, in the window and door frame of the invention, is uniformly applied to the outer surface of the section bars more quickly than the techniques used today;
it improves the aesthetic effect of the window and door frame as a whole, making it linear or devoid of those points of discontinuity of the known window and door frames immediately perceptible by the human eye.

Said purposes and advantages, as well as others that will further emerge, will greatly appear from the following description related to preferred embodiments of the natural thermal cut window and door frame of the invention, given by indicative and illustrative, but not limiting, way in relation to the attached table of drawing in which:

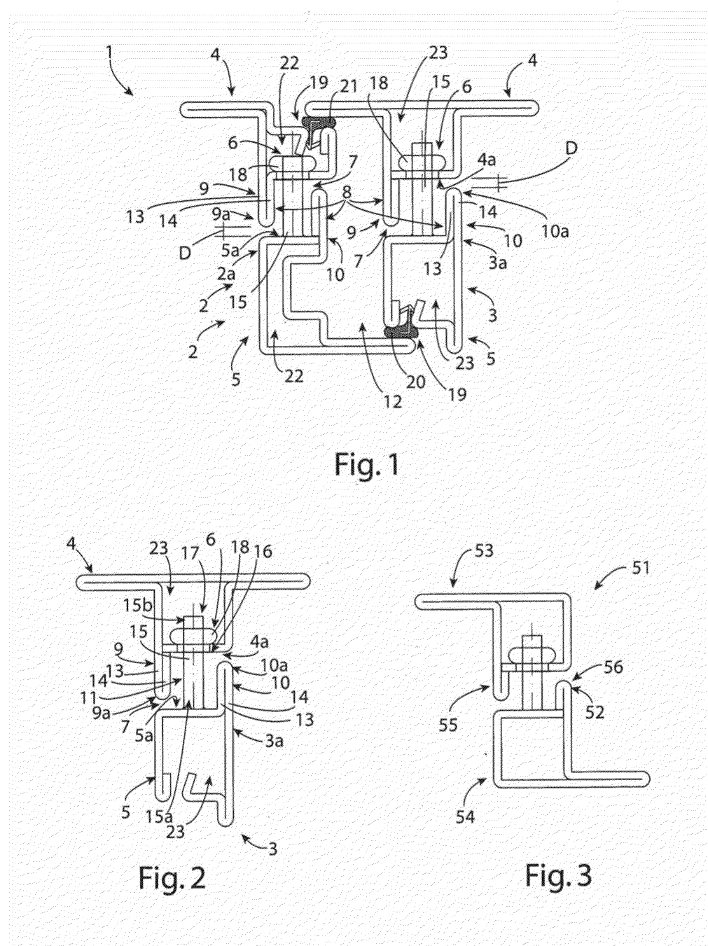

FIG. 1 is a cross section simplified view of the window and door frame of the invention;

FIG. 2 is a first particular of FIG. 1;

FIG. 3 is a view of an executive variant of a first particular of the window and door frame of FIG. 1.

The natural thermal cut window and door frame of the invention is shown in one of his possible embodiments in FIG. 1, where it is globally numbered with 1.

It is observed that the window and door frame 1 comprises:
a first section bar 2, which is fixed to the perimetric wall surrounding a room of a building, not shown for the sake of exposition convenience;
a second section bar 3, cooperating with the first section bar 2 in order to hermetically close the room;
a pair of front panels, not shown, supported by the second section bar 3, and suitable to form the interface between the outer environment and the inner environment of the building.

In accordance with the invention, each of the aforesaid section bars 2, 3 is composed of two shaped portions 4, 5, distinct and independent each other, connected each other through union means, overall indicated with 6, in order to define between the shaped portions 4, 5 a thermal insulation slot 7 which allows air circulation from the outer environment to the inner environment and vice versa, and provided with reinforcement means, on the whole marked with 8, suitable to assure the necessary structural rigidity.

The thermal insulation slot 7 creates within each of the section bars 2, 3 a continuous flow of circulating air which, due to the difference in temperature between the inner environment and the outer environment, forms a natural thermal barrier in any astronomy season.

In practice, therefore, each of the section bars 2, 3 defines a respective inner air chamber 22, 23 which communicates with the surrounding environment through the slot 7 and into which the continuous flow of air forms the aforesaid natural thermal barrier.

The tubular section bars 2, 3 are made of material with high mechanical strength, for example metallic material such as steel of any alloy.

FIG. 1 shows that, in the case at issue, the first section bar 2 presents, as a whole, a substantially Z-shaped profile in cross section.

In turn, the second section bar 3 presents as a whole a substantially T-shaped profile, always in cross section, as it is visible in FIG. 2.

In other embodiments of the invention, not shown herein, the first and the second section bar will present in cross section profiles different from those ones described above: for example, the first section bar will present a substantially T-shaped or L-shaped profile, while the second section bar will present a substantially L-shaped or Z-shaped profile.

It should be noted that, in a preferred but not exclusive manner, the shaped portions 4, 5 of the section bars 2, 3 present a tubular, open and closed respectively, profile, substantially for the entire cross section.

In this case, purely by way of example, the union means 6, and the reinforcement means 8 too, are arranged at the middle zone 2a, 3a of both the section bars 2, 3.

Furthermore, the reinforcement means 8 are at least partly obtained in single piece with the shaped portions 4, 5, according to what will be better clarified shortly.

Preferably, the reinforcement means 8 comprise:
a first tongue, on the whole indicated with 9, projecting orthogonally from a flat inner wall 4a of a first shaped portion 4, such an inner wall 4a being turned towards the thermal insulation slot 7;
a second tongue, on the whole numbered with 10, protruding orthogonally from a flat inner surface 5a of the second shaped portion 5 so as to be spaced part from the first tongue 9, said inner surface 5a being turned towards the thermal insulation slot 7 and directly facing the flat wall 4a.

In particular, the tongues 9 and 10 are facing each and spaced apart each other along a longitudinal direction orthogonal to the linear direction defined by each of said tongues 9, 10.

FIGS. 1 and 2 illustrate that, in a preferred but non binding manner, the first tongue 9 and the second tongue 10 present equal profiles and heights.

Moreover, from a construction point of view, the first tongue 9 and the second tongue 10 are arranged laterally to the union means 6 in respect to which are spaced apart in order to define an intermediate channel 11 of passage of the thermal insulation air.

In the invention, therefore, the reinforcement means 8 (in this case, preferably, the tongues 9 and 10), beyond to their intrinsic function of stiffening, also widely succeed in hiding at sight the union means 6 which firmly connect each other the two shaped portions 4, 5 of each of the section bars 2, 3: such a trick ensures structural continuity to the window and door frame 1 which, consequently, has a linear aesthetic effect, more pleasant than that one offered by the window and door frame of the prior document FR2149360.

With reference to the first section bar 2, the first tongue 9 of the first shaped portion 4 faces the perimetric wall of the room, while the second tongue 10 of the second shaped portion 5 faces the inner chamber 12 defined between the section bars 2, 3.

In relation to the second section bar 3, the first tongue 9 of the first shaped portion 4 faces the inner chamber 12 and the second tongue 10 of the second shaped portion 5 faces the front panels.

What just said clearly represents only one of the possible arrangements of the tongues of the reinforcement means on the shaped portions of the section bar; however, such an arrangement of the tongues 9, 10 (spaced apart and facing each other) allows to get a not negligible advantage during assembly.

Indeed, during assembly of the window and door frame 1, these tongues 9, 10 serve as guide and reference elements for the longitudinal alignment of the shaped portions 4, 5 of each section bar 2, 3, which facilitates the operator (window and door frame maker).

In FIGS. 1 and 2 it is also shown that the first tongue 9 presents a free end 9a spaced apart by a prefixed distance D from the flat inner surface 5a of the second portion 5, as well as the second tongue 10 presents a free end 10a spaced apart by the same prefixed distance D from the flat inner wall 4a of the first portion 4 in order to define the thermal insulation slot 7.

Preferably but not necessarily, each tongue 9, 10 includes a U-bended stretch of the shaped portions 4, 5 in such a way that the tongues 9, 10 are composed of two linear branches 13, 14 parallel and side by side to each other.

More in detail, in the example here described, the bended stretch forming the tongue 9 is made in an inner section of the first shaped portion 4 of the first section bar 2 so that both the linear branches 13, 14 are monolithic with the shaped portions 4, 5 themselves.

The bended stretch forming the tongue 10 and made in an inner section of the second shaped portion 5 of the second section bar 3 presents a similar construction.

Instead, the bended stretch forming the tongue 10 is made in the terminal section of the second shaped section 5 of the first section bar 2 so that one of the linear branches 13, 14 is monolithic with such a shaped portion 5 and the other one is welded, at an end, to the inner surface 5a of the shaped portion 5.

It similarly occurs for the bended stretch forming the tongue 9 and made in the terminal section of the first shaped portion 4 of the second section bar 3: only one of the linear branches 13, 14 of such bended stretch is monolithic with the first shaped portion 4, while the other one is welded, at an end, to the inner wall 4a of the shaped portion 4.

It is understood that in other embodiments of the window and door frame of the invention, not shown in the drawings that follow, the linear stretch forming each tongue of the reinforcement means could be made in an inner section of the shaped portions of the section bars in such a way that both the linear branches are monolithic with the shaped portions themselves.

Conversely, other embodiments of the window and door frame of the invention, not shown in the accompanying drawings, could provide that the linear stretch forming each tongue of the reinforcement means is made in a terminal section of the shaped portions of the section bars in such a way that one of the linear branches is monolithic with the shaped portions and the and other one must be welded, at an end, to the inner surface and/or the inner wall of the shaped portions.

According to the preferred embodiment described herein of the invention, the union means 6 include a plurality of spacing bushings 15 coated with insulating plastic material, each of which provided with an first end 15a permanently coupled with the inner surface 5a of the second shaped portion 5 of the section bars 2, 3 and with a second end 15b coupled with the inner wall 4a of the first shaped portion 4.

More specifically, the second end 15b of each spacing bushing 15 is inserted into a through hole 16 made in the inner wall 4a of the first shaped portion 4 in order to be contained into an upper seat 17 made in the first shaped portion 4, as it is better derived from the best FIG. 2.

In this case, the upper seat 17 is directly determined by the tubular profile of the shaped portions 4, 5 of the section bars 2, 3.

It should be observed in FIGS. 1 and 2 that each spacing bushing 15 is optionally provided with a protective cap 18, applied to the second end 15b of the spacing bushing 15 and therefore contained into the aforesaid upper seat 17: the protective cap 18 increases the thermal insulation capacity of the window and door frame 1.

FIG. 1 also highlights that the window and door frame 1 comprises first seal means, on the whole marked with 19, interposed between the first section bar 2 and second section bar 3.

In detail, the first seal means 19 include, by way of example, a pair of shaped strike seal 20, 21, arranged near the inner part of the tubular section bars 2, 3 from sides opposite each other.

FIG. 3 shows a first executive variant of the first section bar, overall indicated with 51, of the window and door frame of the invention which in this case is not represented in its entirety only for reasons of exposition simplicity.

The first section bar 51, which, similarly to the first section bar 2 of the window and door frame 1, on the whole keeps a substantially Z-shaped profile, differs from such a first section bar 2 mainly for the fact that each tongue 55, 56 of the reinforcement means 52 includes a U-bended stretch made in the terminal section of the shaped portions 53, 54.

In addition, the profiles of the shaped portions 53, 54 of the first section bar 51 are both closed, contrary to what has been indicated for the profiles of the shaped portions 4, 5, and however different from the profiles of the latter, although the first section bar 51 can be coupled without any technical adjustment with a second section bar having a T-shaped profile, of the type indicated with 3 in FIGS. 1 and 2.

By virtue of the foregoing, it is, therefore, understood that the natural thermal cut window and door frame, object of the invention, achieves the purposes and reaches the advantages mentioned above.

In execution, changes could be made to the natural thermal cut window and door frame of the invention consisting, for example, in a number of thermal insulation slots different from that one previously mentioned and illustrated in the accompanying drawings, that number could vary depending on the constructive choices starting from one.

Other embodiments, however not shown, of the window and door frame here claimed may exist in which the two section bars present a not necessarily tubular shape, which does not affect the advantages brought by the present invention.

Moreover, both the union means and reinforcement means can be of different type in further embodiments of the window and door frame of the invention.

Furthermore, in accordance with other embodiments, yet not shown, the natural thermal cut window and door frame, object of the present invention, may include even only one front panel or more than two front panels supported by the second section bar.

It is clear that many other variations may be made to the window and door frame in exam, without departing from the principle of novelty intrinsic in the inventive idea expressed here, as it is clear that, in the practical implementation of the invention, materials, shapes and sizes of the illustrated details can be changed, as needed, and replaced with others technically equivalent.

Where the constructive features and techniques mentioned in the following claims are followed by reference numbers or signs, those reference signs have been introduced with the sole objective of increasing the intelligibility of the claims themselves and therefore they have no limiting effect on the interpretation of each element identified, by way of example only, by these reference signs.

1. Natural thermal cut window and door frame (1) comprising:
a first section bar (2; 51), suitable to be fixed to the perimetric wall delimiting a room of a building;
a second section bar (3; 52) cooperating with said first section bar (2) in order to hermetically close said room;
one or more front panels supported by said second section bar (3), suitable to form the interface between the outer environment and the inner environment of said building,
characterized in that each of said section bars (2, 3; 51) is composed of at least two shaped portions (4, 5; 53, 54) distinct and independent each other, connected each other through union means (6), in order to define between said shaped portions (4, 5; 53, 54) at least one thermal insulation slot (7) suitable to allow air circulation from/to said outer environment to/from said inner environment, and provided with reinforcement means (8) suitable to assure structural rigidity.

2. Window and door frame (1) as claim 1) characterized in that said union means (6) are arranged at the middle zone (2a, 3a) of at least one of said section bars (2, 3; 52).

3. Window and door frame (1) as claim 1) characterized in that said reinforcement means (8; 52) are arranged at the middle zone (2a, 3a) of at least one of said section bars (2, 3; 51).

4. Window and door frame (1) as any of the previous claims characterized in that said reinforcement means (8; 52) are at least partially obtained in single piece with said shaped portions (4, 5; 53, 54).

5. Window and door frame (1) as any of the previous claims characterized in that said reinforcement means (8; 52) include:
a first tongue (9; 55) projecting orthogonally from a flat inner wall (4a) of a first of said shaped portions (4, 5; 53, 54), said inner wall (4a) being turned towards said thermal insulation slot (7);
a second tongue (10; 56) projecting orthogonally from a flat inner surface (5a) of the second of said shape portions (4, 5; 53, 54) so as to be spaced apart from said first tongue (9; 55), said flat surface (5a) being turned towards said thermal insulation slot (7) and facing said flat wall (4a).

6. Window and door frame (1) as claim 5) characterized in that said first (9; 55) and second tongue (10; 56) present profiles and heights equal each other.

7. Window and door frame (1) as claim 5) or 6) characterized in that said first (9; 55) and second tongue (10; 56) are facing each other and arranged laterally to said union means (6) with respect to which are spaced in order to define an intermediate channel (11) of passage of said thermal insulation air.

8. Window and door frame (1) as claim 5), 6) or 7) characterized in that, with reference to said first section bar (2; 51), said first tongue (9; 55) of said first shaped portion (4; 53) faces said perimetric wall of said room and said second tongue (10; 56) of said second shaped portion (5; 54) faces the inner chamber (12) defined between said section bars (2, 3; 51), while, with reference to said second section bar (3), said first tongue (9) of said first shaped portion (4; 53) faces said inner chamber (12) and said second tongue (10) of said second shaped portion (5; 53) faces said front panels.

9. Window and door frame as any of the claims from 5) to 8) characterized in that said first tongue (9; 55) presents a free end (9a) spaced apart by a prefixed distance (D) from said flat inner surface (5a) of said second portion (5; 54) and said second tongue (10; 56) presents a free end (10a) spaced apart by said prefixed distance (D) from said flat inner wall (4a) of said first portion (4; 53) in order to define said thermal insulation slot (7).

10. Window and door frame (1) as any of the claims from 5) to 9) characterized in that each of said tongues (9, 10; 55, 56) includes a U-bended stretch of said shaped portions (4, 5; 53, 54) so that said tongue (9, 10; 55, 56) are composed of two linear branches (13, 14) parallel and side by side each other.

11. Window and door frame (1) as claim 10) characterized in that said bended stretch of at least one of said shaped portions (4, 5; 53, 54) is made in an inner section of said shaped portions (4, 5; 53, 54) so that both said linear branches (13, 14) are monolithic with said shaped portions (4, 5; 53, 54).

12. Window and door frame (1) as claim 10) or 11) characterized in that said bended section of at least one of said shaped portions (4, 5; 53, 54) is made in a terminal section (4c, 5c) of said shaped portions (4, 5; 53, 54) so that one of said linear branches (13, 14) is monolithic with said shaped portions (4, 5; 53, 54) and the other is welded, for an end, to said inner surface (5a) and/or said inner wall (4a) of said shaped portions (4, 5; 53, 54).

13. Window and door frame (1) as any of the claims from 5) to 12) characterized in that said union means (6) comprise a plurality of spacing bushings (15) coated with plastic insulating material, each of which equipped with a first end (15a) firmly coupled with said inner surface (5a) of said second shaped portion (5; 54) of said section bars (2, 3; 51) and a second end (15b) coupled with said inner wall (4a) of said first shaped portion (4; 53).

14. Window and door frame (1) as claim 13) characterized in that said second end (15b) of each of said spacing bushings (15) is inserted into a through hole (16) made in said inner wall (4a) of said first shaped portion (4; 53) in order to be contained into an upper seat (17) made in said first shaped portion (4; 53).

15. Window and door frame (1) as any of the previous claims characterized that said shaped portions (4, 5; 53, 54) of said section bars (2, 3; 51) present a tubular profile substantially for the entire cross section.
